(19) United States
(12) Patent Application Publication
(10) Pub. No.: US 2015/0039794 A1
(43) Pub. Date: Feb. 5, 2015

(54) Multifunction Interface for Patient Monitoring

(71) Applicant: Rondish Company Limited, Kwai Chung N.T. (CN)

(72) Inventor: Steven Alfred Williams, Kwai Chung (CN)

(21) Appl. No.: 14/450,193

(22) Filed: Aug. 1, 2014

Related U.S. Application Data
(60) Provisional application No. 61/861,255, filed on Aug. 1, 2013.

(51) Int. Cl. G08B 25/01; G08B 7/06; G08C 19/00; G06F 13/42

(52) U.S. Cl. CPC G08B 25/016; G06F 13/4286; G08B 7/06; G08C 19/00
USPC 710/106

(57) ABSTRACT

A multifunction interface unit allows for the connection of two or more devices to a nurse call system. The interface unit may include two or more sockets for receiving wired communication from two or more patient monitoring devices. Further, the interface unit may include one or more of a transceiver, receiver, and transmitter for wireless communication with two or more patient monitoring devices.

### CROSS-REFERENCE TO RELATED APPLICATION

This application claims benefit of U.S. Provisional Application No. 61/861,255, titled “Multifunctional Alarm Interface for Patient Monitoring,” filed Aug. 1, 2013, the disclosure of which is hereby incorporated by reference in its entirety herein.

### BACKGROUND

Patients in a hospital or patient care center often are monitored by one or more nurses that are generally situated a nurse station. The patients typically have access to an emergency or nurse call system that the patient can actuate to notify a nurse that assistance is needed. It is the case that many emergency and nurse-call alarm systems only have a limited quantity of inputs to the system that can be used to trigger the system. The single or limited input is usually reserved for an external call cord handset.

However, a patient may often be monitored by several monitoring devices, each of which may have need for access to the nurse call system to notify a nurse upon occurrence of a monitored event. The limited quantity of inputs to the nurse call system can therefore be disadvantageous.

### SUMMARY

Disclosed is a multi-function interface unit that allows multiple devices to interact with a nurse call system through a single port or socket into the nurse call system.

In some embodiments, an interface unit for connecting two or more devices to a nurse call system is described. The Interface unit includes a plug configured to connect to the nurse call system and two or more device sockets configured to allow communication between the interface unit and two or more monitoring devices.

The following features may be present in the interface unit in any suitable combination. The interface unit may also include an inlet for a power source. Additionally, or alternatively, the interface unit may also include one or more of any of the following: a receiver, a transmitter, and a transceiver. The interface unit may include an indicator light configured to indicate the state of power of the interface unit. The two or more patient monitoring device may include at least two of a patient monitoring bed pad, a patient monitoring floor mat, a nurse call button, a bedside monitoring device, and a physiological parameter monitor in some embodiments. In such embodiments, the physiological parameter monitor may include a hear rate monitor, an oxygen sensor, a blood pressure sensor or monitor, a temperature sensor or monitor, or any combination thereof.

In a related aspect, a system for connecting two or more devices to a nurse call system at a single connection is described in some embodiments. The system includes a socket for accepting connection to the nurse call system and an interface unit. The interface unit includes a plug configured to connect to the nurse call system in the socket and two or more device sockets configured to allow communication between the interface unit and two or more patient monitoring devices.

The following features may be present in the system in any suitable combination. The system may include a power supply connected to the interface unit. The power supply may be configured to support communication between the interface unit and monitoring devices that are connected to the interface unit. The system may include an adaptor that attaches to the plug of the interface unit on a first end and to the nurse call system socket on a second end. The interface unit may communicate with the two or more patient monitoring devices through any of wired connections, wireless connections, and a combination of wired and wireless connections.

Other features and advantages should be apparent from the following description of various embodiments, which illustrate, by way of example, the principles of the disclosure.

### BRIEF DESCRIPTION OF THE DRAWINGS

FIG. 1 shows an embodiment of a multi-function interface unit.

FIG. 2A shows a multi-function interface unit plugging into a socket of a nurse call system.

FIG. 2B shows a configuration of a system that includes a multi-function interface unit and multiple patient monitoring devices.

FIG. 3 shows another configuration of a system that includes a multi-function interface unit and multiple patient monitoring devices, in which the multi-function interface unit connects to an external power supply.

FIG. 4 shows a configuration of a system that includes a multi-function interface unit and multiple patient monitoring devices, in which the multi-function interface unit communicates wirelessly with some of the patient monitoring devices.

FIG. 5 shows a configuration of a system that includes a multi-function interface unit and multiple patient monitoring devices, in which the multi-function interface unit connects to one or more adaptors.

### DETAILED DESCRIPTION

Disclosed is a coupling device configured to couple to a nurse call system and permit the nurse call system to interface with several devices that each can trigger the nurse call system to issue an alert. Thus, multiple devices can trigger the nurse call system. The device plugs into a nurse call system either by a physical or a wireless connection. Once coupled to the nurse call system, the device maintains the original connection and function of an external call cord handset coupled to the nurse call system.

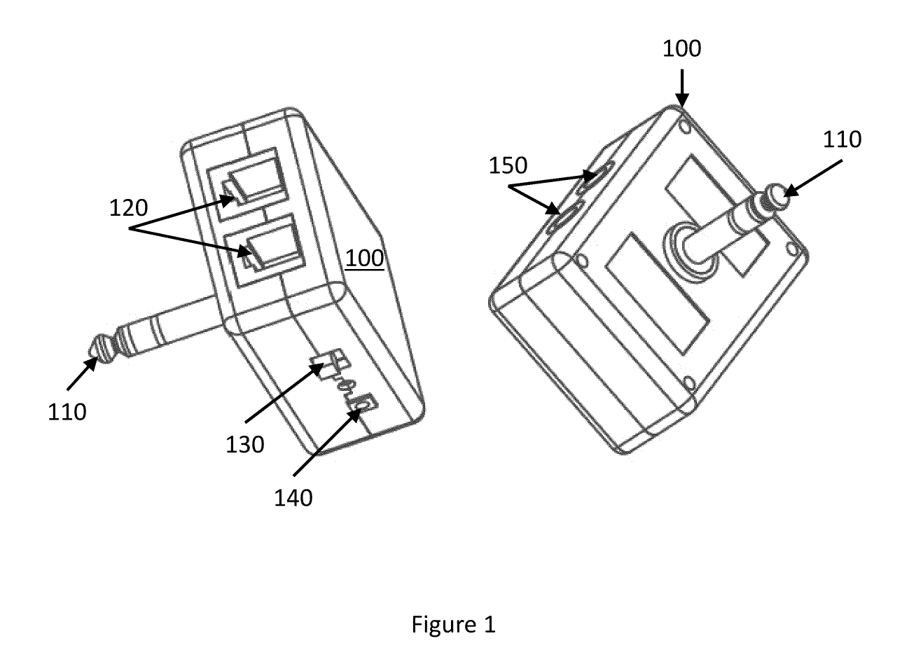

FIG. 1 shows an embodiment of a coupling device that is a multi-function interface unit 100. The interface unit 100 has a plug 110, input jacks 120, a system switch 130, a power inlet 140, and one or more inlets for patient monitoring devices 150. The plug 110 may be sized and shaped to fit into a standard socket for plugging devices into a nurse call system. In some embodiments, the plug 100 may be non-standard, then the interface unit 100 (coupling device) can be placed next to the panel at the head of the bed and an adaptor cable may be used to connect with the nurse-call system. In such embodiments, the original call cord device may in turn plug into the interface unit 100. The cases in which an adaptor may be used, will be discussed in more detail below. Multiple types of wired connections can be made to the interface unit 100 using the jacks 120 and the other inlets 150. Such connections may include Ethernet connections, USB connections, RS22 connections, firewire connection, other electrical connections, optical or opti-electric connections, and the like.

The multi-function interface unit 100 may draw power exclusively from the nurse call system, once connected. Alternatively, the interface unit 100 may connect to a power source. The power source may be a power supply that plugs into a wall socket. Batteries may also supply power to the interface unit 100. In some implementations, the interface unit 100 may use more than one type of power source, and may have one or more power inlet 140 to accommodate the power sources.

There may be more than one mode in which the interface unit 100 may operate. These modes may be based at least partially upon the type of power interface unit 100 requires, as well as the types of connections being made. There may be a switch 130 on the interface unit 100 that indicates the operating mode of the interface unit 100 or the type of system.

In an embodiment, the interface unit 100 (e.g., coupling device) is plugged into the nurse-call socket 200 and the original or a new call cord 230 is then plugged into the device to allow normal nurse-call function. One or more volt-free open circuit devices can be connected into the device such as bed monitor outputs 220 and floor mats 210 without the need for any form of power. A switch 130 or other actuator permits the selection of a “NO” or “NC” circuit connection.

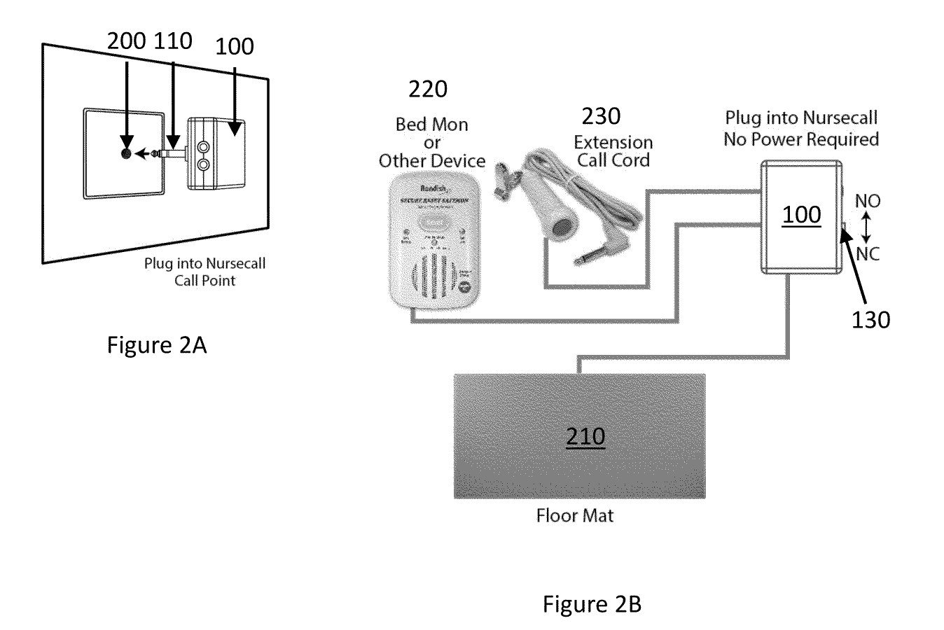

FIG. 2A shows a multi-function interface unit 100 plugging into a socket 200 of a nurse call system. The socket 200 is designed to accept only one plug 110, and thus normally accepts only one device at that connection. By using the multi-function interface unit 100, a user may connect two or more patient monitoring devices to the nurse call system.

A system may have a configuration that includes a multi-function interface unit 100 and multiple patient monitoring devices, without the need for external power, as shown in FIG. 2B. Patient monitoring devices that may be connected to the interface unit 100 include a patient monitoring pad, a floor mat 210, a bedside patient monitor 220, and a nurse call button 230. The devices may be able to trigger the nurse call system, indicating to a nurses' station that the patient associated with that location needs assistance. Alternatively, or additionally, the devices may trigger an alarm signal through the nurse call system.

The alarm signal can be an audio signal, a visual signal, or both an audio and visual signal. An audio signal can be a sustained sound, an instantaneous sound, and/or a repeating sound. A visual signal can be a flashing light, an indicator light, a message on a user interface, or any combination thereof. A message can be a message on a user interface, a message sent to an external device, or an audio message. A message can also be an audio telephonic message sent to a land-line, a mobile phone, or a voice-mail account. Additionally, a message can be a text-based or icon based message, such as a short message service message (i.e. SMS text message), an e-mail, or a multimedia messaging service message received on a mobile phone, pager, or hand-held device that is configured to send and receive data using cellular phone signaling means. The nurse call system may issue any of the above alarm signals to alert one or more care givers. Some of the devices themselves may issue alarm signals themselves, in addition to triggering alarm signals on the nurse call system.

The devices are shown as having a wired connection to the interface unit 100 in FIG. 2B. No power besides that provided by the nurse call system or the connected devices is needed in this configuration. A switch 130 indicates that the interface unit 100 is currently in a “NC,” or nurse call, configuration. The NC configuration is used when the power supplied by the nurse call system is not augmented or supplemented with another power supply.

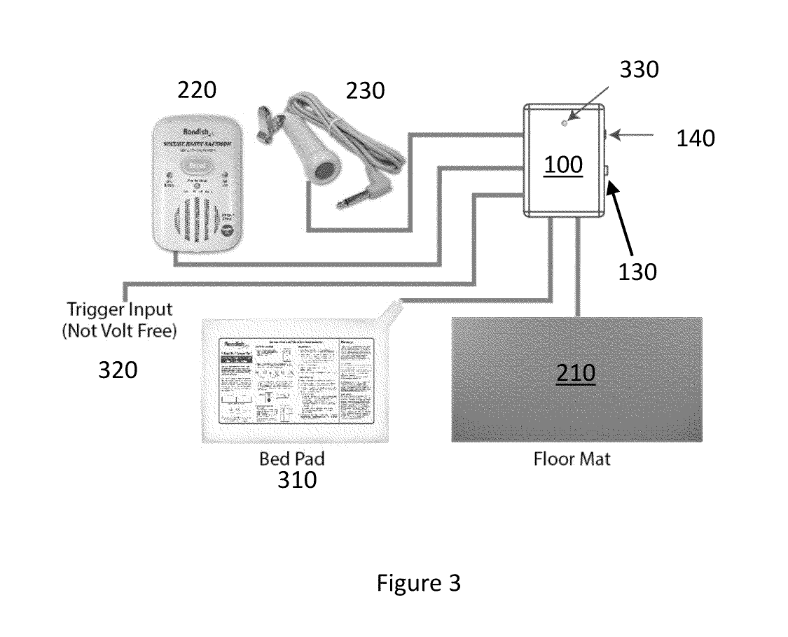

Another configuration for a system with multiple patient monitoring devices and an interface unit 100 for connecting to a nurse call system is shown in FIG. 3. In the system, the interface unit 100 is shown connected to a power supply 140, as well as to multiple devices. The interface unit 100 may be in a configuration that accepts external power, and in turn, the switch 130 may indicate such a configuration. The switch 130 may indicate the “NO” configuration (as seen in FIG. 2B) when in the system of FIG. 3. The devices that may be connected to the interface unit 100 include a floor mat 210, a bed side patient monitor 220, a nurse call button 230, a patient monitoring pad 310, and any other device that may trigger the nurse call system 320. Wires are shown connecting the devices to the interface unit 100. The devices may require the interface unit 100 to have an external power supply 140 to enable communication of data. An indicator light 330 on the interface unit 100 may help a user to confirm that the power supply is adequately providing energy to the interface unit 100. Further, any device with a standard output with a wide range of voltage (0-50V Dc) from any trigger device to allow various options may be connected to the interface unit 100. In such a scenario, the interface unit 100 (coupling device) acts as a buffer when an active input is provided, as the interface unit 100 provides a volt free input to the nurse-call system.

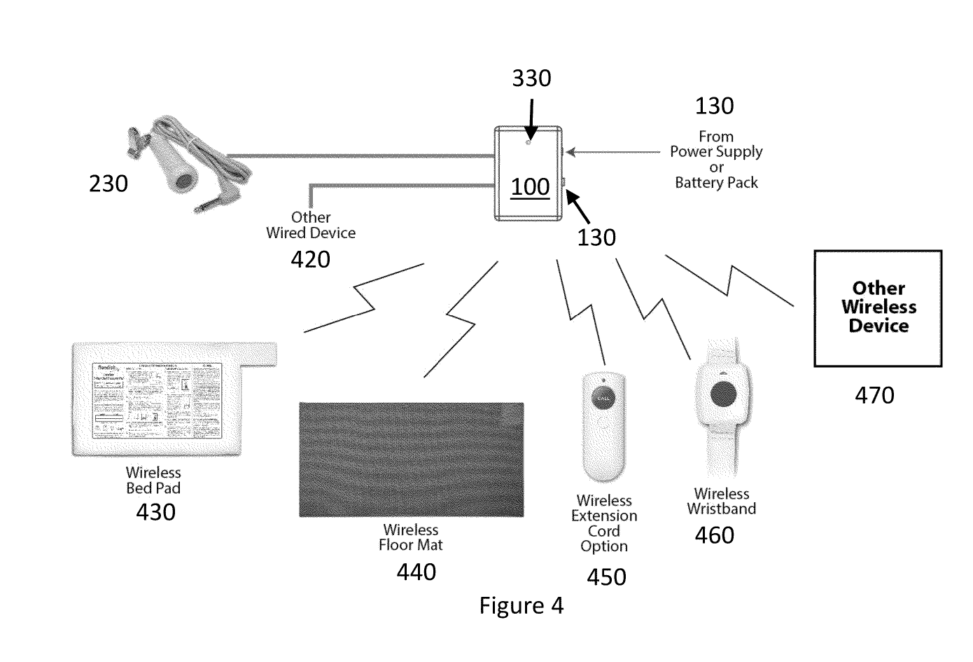

A configuration of a system that includes a multi-function interface unit 100 and multiple patient monitoring devices that communicate wirelessly is shown in FIG. 4. As in FIG. 3, the interface unit 100 is connected to an external power supply 140 and has an indicator light 330 that allows a user to quickly determine whether sufficient energy is provided to the interface unit 100. The switch 130 on the interface unit 100 may be in a position indicating that external power is needed.

The devices that may connect to the interface unit 100 include some wirelessly connected devices and some devices connected via physical wires. The devices that are connected using physical wires to the interface unit 100 may include a nurse call button 230 and other wired device 420. Devices that may connect wirelessly with the interface unit 100 may include a wireless patient monitoring pad 430, a wireless floor mat 440, a wireless extension cord 450, a wireless bracelet with a nurse call button 460, and another wireless device 470.

Wireless connections between the wireless patient monitoring devices and the interface unit 100 can utilize any suitable wireless system, such as Bluetooth, WiFi, radio frequency, Zigbee communication protocols, infrared, cellular phone systems, and the like. Coding or authentication may verify the origin of the information received by either or both the interface unit 100 and the patient monitoring devices. The interface unit 100 may include one or more of a receiver, a transmitter, and a transceiver so that wireless connections may take place.

As mentioned above, though the interface unit 100 may have a plug that is generally sized and shaped to plug into a socket for communicating with a nurse call system, occasionally the plug may need an adaptor to fit into the socket 200. Alternatively, or additionally, it may be desired to position the interface unit 100 in a different position in a patient's room than that of the socket 200. In such a case, a cord 590 may be used. The cord may have an adaptor, if needed. In such a configuration, the interface unit 100 may have an indicator light 330 that shows whether or not sufficient connection or power is achieved in the system, particularly at the interface unit 100.

The devices connecting to the interface unit 100 can include physically connected devices 520, such as a bedside monitor, a patient monitoring pad, and the like. Wirelessly connected devices 530 may also connect to the interface unit 100. Further, a wireless signal extender 450, which itself may be connected via wire, may also connect to the interface unit 100. The wireless call button signal extender 450 may be swapped out with a patient monitoring device. The connecting cord may allow for a quick exchange of the signal extender 450 and another device. A junction between a cord socket 570 and a cord plug 580 may allow for such quick exchanges. Alternatively, or additionally, the junction on the cord may allow for a short cord attached to a call button to be exchanged for a longer cord, to better suit the position of the patient relative to the interface unit 100.

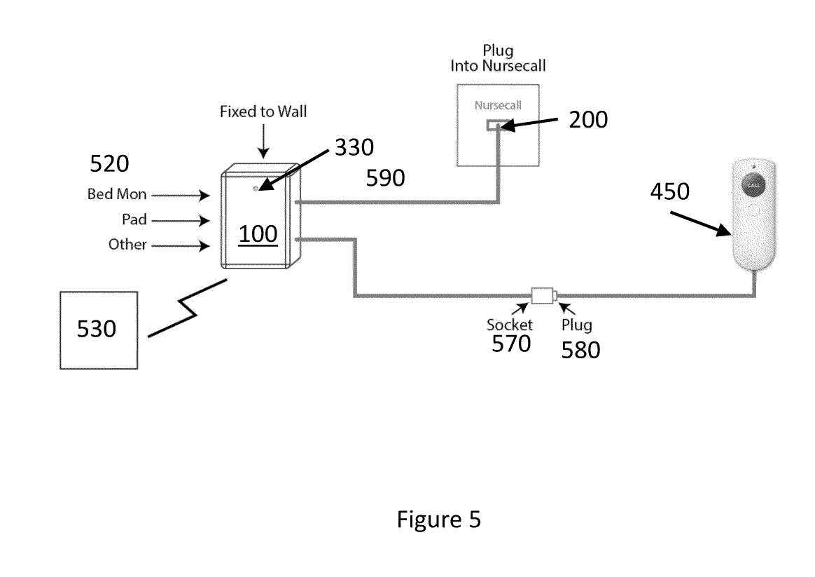

In all configurations shown in FIGS. 2B-5, there may be common features. The interface unit 100 (e.g., coupling device) is configured such that it permits all devices connected to the interface unit 100 to detect any disconnections between the devices and the interface unit 100. These disconnections may be indicated by the interface unit 100 or using the nurse call system.

In an embodiment, the interface unit 100 (e.g., coupling device) includes an optional wireless receiver to allow signal the interface unit 100 from various transmitter sensor devices. The interface unit 100 may include one or more systems configured to verify receipt of a signal (from a connected device) and that the complete system works correctly.

The interface unit 100 may include any of a variety of indicators such as visual indicators (e.g., an LED 330 to indicate power on and status) and audio speakers. The interface unit 100 can powered in a variety of manners, including for example with internal batteries (e.g., standard or rechargeable), an external power supply, or an external battery pack. A variety of input protocols may account for different connectors that work with the interface unit 100.

While this specification contains many specifics, these should not be construed as limitations on the scope of an invention that is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Although embodiments of various methods and devices are described herein in detail with reference to certain versions, it should be appreciated that other versions, methods of use, embodiments, and combinations thereof are also possible. Therefore the spirit and scope of the appended claims should not be limited to the description of the embodiments contained herein.

What is claimed is:

1. An interface unit for connecting two or more devices to a nurse call system, the interface unit comprising:
a plug configured to connect to the nurse call system; and
two or more device sockets configured to allow communication between the interface unit and two or more patient monitoring devices.

2. The interface unit of claim 1, further comprising an inlet for a power source.

3. The interface unit of claim 1, further comprising one or more of any of the following: a receiver, a transmitter, and a transceiver.

4. The interface unit of claim 1, further comprising an indicator light configured to indicate the state of power of the interface unit.

5. The interface unit of claim 1, wherein the two or more patient monitoring devices comprise at least two of a patient monitoring bed pad, a patient monitoring floor mat, a nurse call button, a bedside monitoring device, and a physiological parameter monitor.

6. The interface unit of claim 5, wherein the physiological parameter monitor comprises a heart rate monitor, an oxygen sensor, a blood pressure sensor or monitor, a temperature sensor or monitor, or any combination thereof.

7. A system for connecting two or more devices to a nurse call system at a single connection, the system comprising:
a socket for accepting connection to the nurse call system; and
an interface unit comprising:
a plug configured to connect to the nurse call system in the socket; and
two or more device sockets configured to allow communication between the interface unit and two or more patient monitoring devices.

8. The system of claim 7, further comprising a power supply connected to the interface unit, the power supply configured to support communication between the interface unit and monitoring devices connected to the interface unit.

9. The system of claim 7, further comprising an adaptor that attaches to the plug of the interface unit on a first end and to the socket on a second end.

10. The system of claim 7, wherein communication between the interface unit and the two or more patient monitoring devices comprises any of wired connections, wireless connections, and a combination of wired and wireless connections.
